(19) United States
(12) Patent Application Publication
(10) Pub. No.: US 2014/0166233 A1
(43) Pub. Date: Jun. 19, 2014

(54) UNDER CAB HVAC CASSETTE MODULE

(71) Applicant: DEERE & COMPANY, Moline, IL (US)

(72) Inventor: Todd M. Wehrenberg, Sherrill, IA (US)

(73) Assignee: Deere & Company, Moline, IL (US)

(21) Appl. No.: 13/716,260

(22) Filed: Dec. 17, 2012

(51) Int. Cl. B60H 1/00

(52) U.S. Cl. CPC B60H 1/00007
USPC 165/42; 165/64

(57) ABSTRACT

The present disclosure provides a cassette module for a HVAC system of a machine. The cassette module includes an outer case having a first side and a second side. The outer case includes a first flange disposed at the first side and a second flange disposed at the second flange such that the first flange is adapted to couple to a first HVAC duct and the second flange is adapted to couple to a second HVAC duct. The module also includes an evaporator assembly including at least one flange for coupling to the outer case. The evaporator assembly is at least partially enclosed by the outer case. A heater assembly also includes at least one flange for coupling to the outer case. The heater assembly is disposed adjacent to the evaporator assembly and is at least partially enclosed by the outer case.

### FIELD OF THE DISCLOSURE

The present disclosure relates to a heating, ventilation, and air conditioning (HVAC) system for a machine, and in particular, to a cassette-style packaging arrangement of a HVAC system.

### BACKGROUND OF THE DISCLOSURE

Work machines, such as those in construction and forestry applications, include a cab mounted to the frame of the machine where an operator controls the operation and movement of the machine. In many conventional machines, the cab defines an interior that includes controls (e.g., steering wheel, lever, joystick, buttons, displays, etc.), a seat for the operator, and the heating, ventilation, and air conditioning (HVAC) system. Other features may also be stored or disposed in the interior of the cab. The HVAC system, however, can occupy a large area in the cab. In some instances, the HVAC system can be mounted behind removably panels in the cab. Due to the space occupied by the HVAC system, it can be difficult to service or replace hardware and other components of the system.

Moreover, with the HVAC system substantially disposed within the cab, it can be difficult to move air in the cab to keep it properly ventilated and maintain a desired temperature. The HVAC system includes one or more fluid lines or hoses through which refrigerant, engine coolant, and other fluids pass. If any one of the fluid lines or hoses leaks, the fluid can leak directly onto the floor of the cab. In addition, condensation can be produced by the HVAC system, and in some instances, leak into the cab as well. If condensation builds or pools in the cab, an undesirable mold or mildew spell can develop inside of the cab.

A need therefore exists to provide a reconfigured HVAC system packaged in a location outside of the cab space. It is further desirable to package the HVAC system in an easily serviceable manner to facilitate reduced service time and ease of replacement of damaged or worn hardware.

### SUMMARY

In an exemplary embodiment of the present disclosure, a cassette module is provided for a HVAC system of a machine. The cassette module includes an outer case having a first side and a second side. The outer case includes a first flange disposed at the first side and a second flange disposed at the second flange such that the first flange is adapted to couple to a first HVAC duct and the second flange is adapted to couple to a second HVAC duct. The module also includes an evaporator assembly including at least one flange for coupling to the outer case. The evaporator assembly is at least partially enclosed by the outer case. A heater assembly also includes at least one flange for coupling to the outer case. The heater assembly is disposed adjacent to the evaporator assembly and is at least partially enclosed by the outer case.

In one aspect, the evaporator assembly and heater assembly are disposed adjacent to one another within the outer case. In another aspect, the module includes a thermal expansion valve for metering fluid flow to or from the evaporator assembly, where the thermal expansion valve is coupled to the evaporator assembly. A boot member is provided for substantially covering the thermal expansion valve. In a different aspect, a water valve coupled to one of the outer case, the evaporator assembly, or the heater assembly. Moreover, the cassette module can include a first gasket and a second gasket. The first gasket is disposed between the evaporator assembly and the outer case and the second gasket is disposed between the heater assembly and the outer case.

In yet another aspect, the cassette module includes a freeze probe adapted to detect a temperature in the evaporator assembly. The freeze probe is coupled to the outer case or evaporator assembly. A bracket is coupled between the outer case, evaporator assembly, and heater assembly. In a further aspect, the cassette module can include a first plurality of fluid lines and a second plurality of fluid lines. The first plurality of fluid lines is coupled to the evaporator assembly and the second plurality of fluid lines is coupled to the heater assembly. In addition, the outer case includes defined openings through which the first plurality of fluid lines and second plurality of fluid lines protrude.

In another embodiment, a machine is provided having at least one traction device. The machine includes a frame adapted to be supported by the at least one traction device and a cab pivotably coupled to the frame, where the cab includes a floor panel. The machine also includes a HVAC system having a first portion and a second portion. The first portion is at least partially disposed in the cab and the second portion is coupled to the floor panel substantially underneath the cab. The second portion includes a HVAC cassette module accessible from outside the cab.

In one aspect, the HVAC cassette module includes an outer case being removably coupled to the second portion of the HVAC system, an evaporator assembly coupled to and being at least partially enclosed by the outer case, and a heater assembly coupled to and being at least partially enclosed by the outer case. In another aspect, the first portion comprises a blower motor and a filter, where the blower motor and filter are accessible from inside the cab. Moreover, the evaporator assembly and heater assembly are disposed adjacent to one another within the outer case. In a different aspect, a thermal expansion valve is provided for metering fluid flow to or from the evaporator assembly such that the thermal expansion valve is coupled to the evaporator assembly.

In yet another aspect, the cassette module can include a water valve coupled to the second portion of the HVAC system or the cassette module. In addition, a freeze probe is adapted to detect a temperature in the evaporator assembly such that the freeze probe is coupled to the outer case or evaporator assembly. The cassette module further includes a bracket coupled between the outer case, evaporator assembly, and heater assembly. In a further aspect, a first plurality of fluid lines and a second plurality of fluid lines are provided such that the first plurality of fluid lines is coupled to the evaporator assembly and the second plurality of fluid lines is coupled to the heater assembly. The outer case includes defined openings through which the first plurality of fluid lines and second plurality of fluid lines protrude.

The machine can further include a first duct disposed underneath the cab, where the first duct is coupled between the first portion and the HVAC cassette module. Also, a second duct is disposed underneath cab, where the second duct is coupled to the HVAC cassette module and has a first duct path and a second duct path. Moreover, at least one condensate drain is coupled to the second portion of the HVAC system and disposed underneath the cab.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side perspective view of a grapple skidder;

FIG. 2 is a top view of a conventional cab of a work machine;

FIG. 3 is a rear perspective view of the conventional cab of FIG. 2;

FIG. 4 is a top view of a rearranged cab of a machine in accordance with an exemplary embodiment of the present disclosure;

FIG. 5 is a bottom perspective view of the cab of FIG. 4;

FIG. 6 is a perspective view of a HVAC system coupled to the cab of FIG. 4;

FIG. 7 is a HVAC cassette module of the system of FIG. 6; and

FIG. 8 is an exploded view of the module of FIG. 7.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

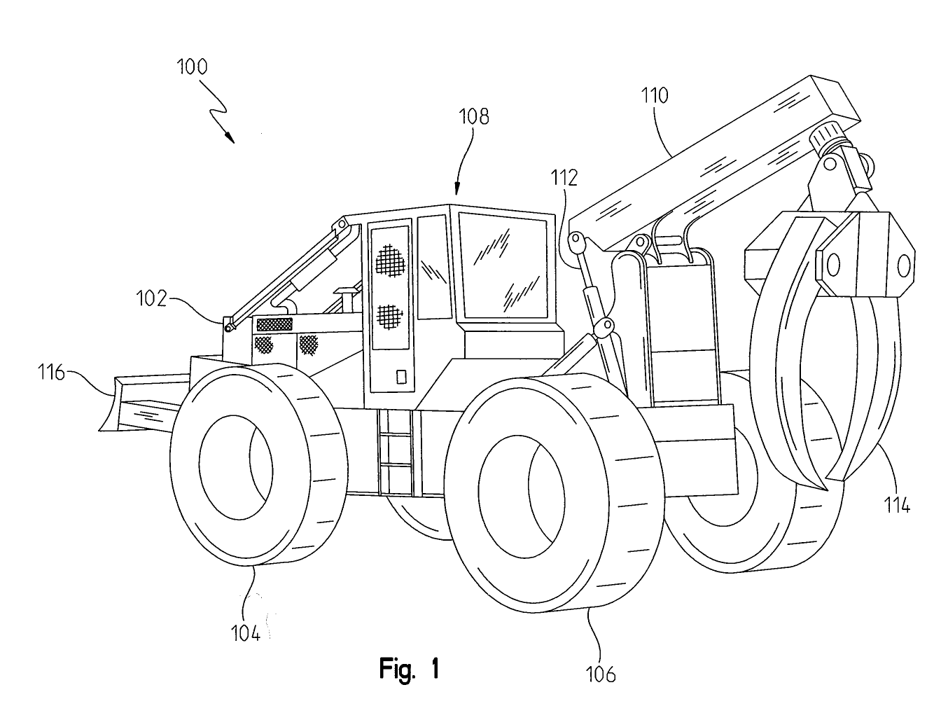

Referring to FIG. 1, an exemplary embodiment of a work machine is illustrated. Here, a grapple skidder 100 is shown. The skidder 100 includes an outer frame and chassis 102 to which a front traction device 106 and rear traction device 104 are mounted. The front and rear traction devices can be wheels or tracks for moving the skidder 100 along the ground. A cab 108 is also mounted to the frame and chassis 102 of the skidder 100. The cab 108 can include controls such as a joystick, lever, pedals, buttons, switches, and the like for controlling the operation of the skidder 100. A seat for a machine operator may also be disposed in the cab 108. In addition to the cab, a boom 110 may be operably coupled to the frame and chassis 102 for controlling a work implement 114. In FIG. 1, the work implement 114 is shown as a grapple. However, the work implement may also be a bucket, auger, broom, forklift, or other known tools. The boom 110 can be controlled by one or more hydraulic cylinders 112. On the opposite side of the frame and chassis 102 can be a second work implement 116. The second work implement 116 can be a blade, for example. Alternatively, the second work implement 116 can be any other known tool.

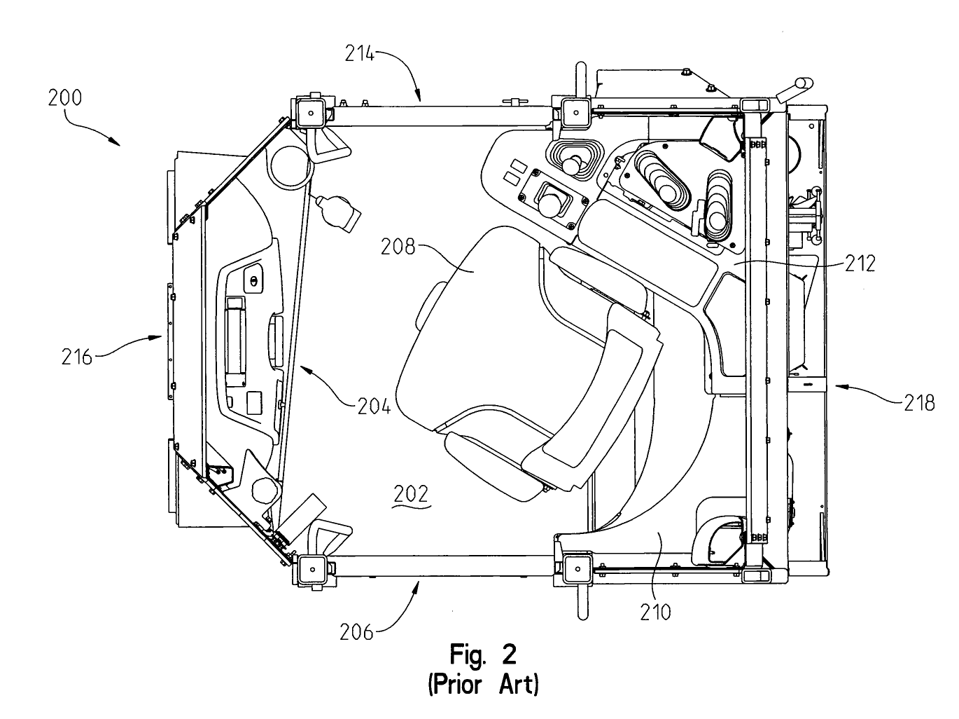

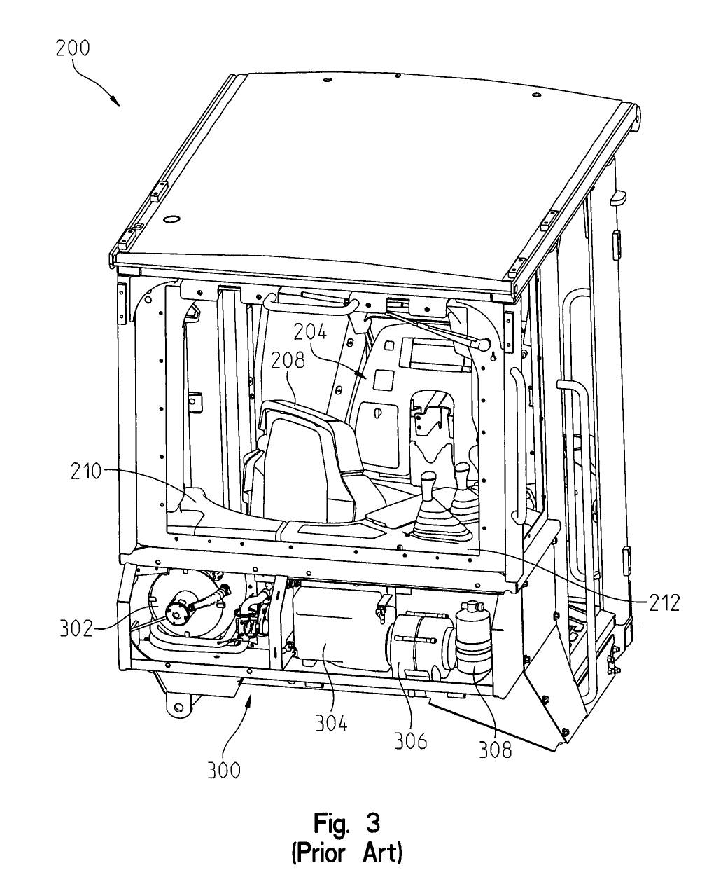

The present disclosure is not limited to a grapple skidder, however, and can extend to other work machines (e.g., cable skidder, crawler, feller buncher, harvester, etc.). With reference to FIGS. 2 and 3, a conventional cab 200 for a skidder, feller buncher, etc. is illustrated. As shown, the cab 200 includes an interior 202 defined by at least an upper wall, a floor, a first side 206, a second side 214, a third side 216, and a fourth side 218. The front and rear of the cab 200 may be any one of the aforementioned sides. The cab 200 includes a dashboard, monitor, and control assembly 204 for controlling the machine. An operator can sit in a chair 208 mounted to the floor of the cab 200.

The cab 200 also contains at least a portion of the HVAC system of the machine. In FIG. 2, the HVAC system includes a first portion 210 and a second portion 212 disposed between the first side 206 and second side 214, and opposite the controls 204. With the first portion 210 and second portion 212 of the HVAC system disposed in the cab 200, the interior 202 of the cab 200 is substantially reduced. In FIG. 2, in particular, the seat 208 cannot rotate 180° due to the size and location of the HVAC system being behind the seat 208. The HVAC system can be enclosed by panels (partially shown in FIG. 2) inside the cab 200. The HVAC system is difficult to service due to its location inside the cab 200. In some instances, the seat 208 is removed to access either the first portion 210 or second portion 212 of the system. In FIG. 3, the cab 200 may provide limited service access through a rear panel to service a rear portion 300 of the HVAC system. For example, a motor blower 302, air intake ducting 304, pre-cleaner impellor 306, or receiver dryer 308 can be accessed through this rear panel and serviced. If a HVAC core of the system, however, needs serviced or replaced the only access is through one of the panels in the cab 200. Thus, the conventional cab 200 can be overly crowded such that maintenance of the HVAC system is difficult and labor intensive.

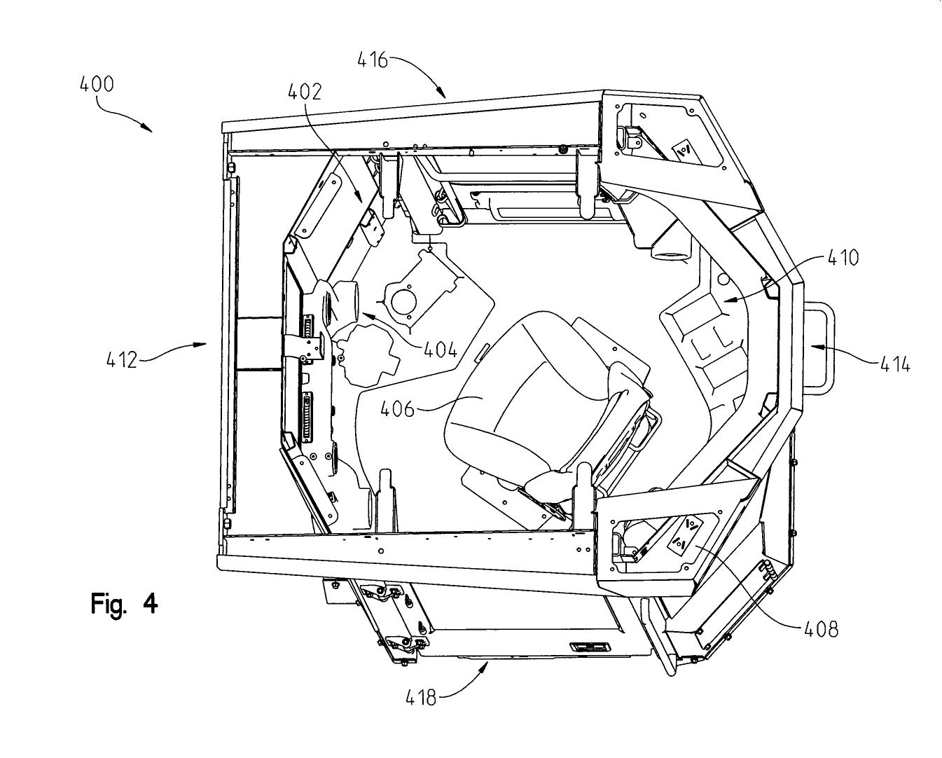

The obstacles of the conventional cab 200 and previously-described HVAC system are overcome by the different embodiments of the present disclosure. Referring to FIG. 4, for example, an exemplary embodiment of a modified cab 400 for a skidder, feller buncher, or other machine is shown. The cab 400 includes an interior space 402 that is defined by a first side 412 or front, a second side 414 or rear, a third side 416, and a fourth side 418. The cab 400 can also include a dashboard, display, and control system 404 and a seat 406 mounted to a floor of the cab 400. The interior 402 of the cab 400 in FIG. 4 is not occupied by the first and second portions of the HVAC system of FIG. 2. Instead, a smaller portion 408 of the HVAC system is disposed in a corner near the second side 414 and fourth side 418 for containing a blower and filter. Therefore, the blower motor and filter can be serviced inside the cab 400, but the majority of other components of the HVAC system are not disposed in the cab 400. Moreover, the seat 406 can now be rotatably mounted in the cab 400 with the HVAC system removed therefrom.

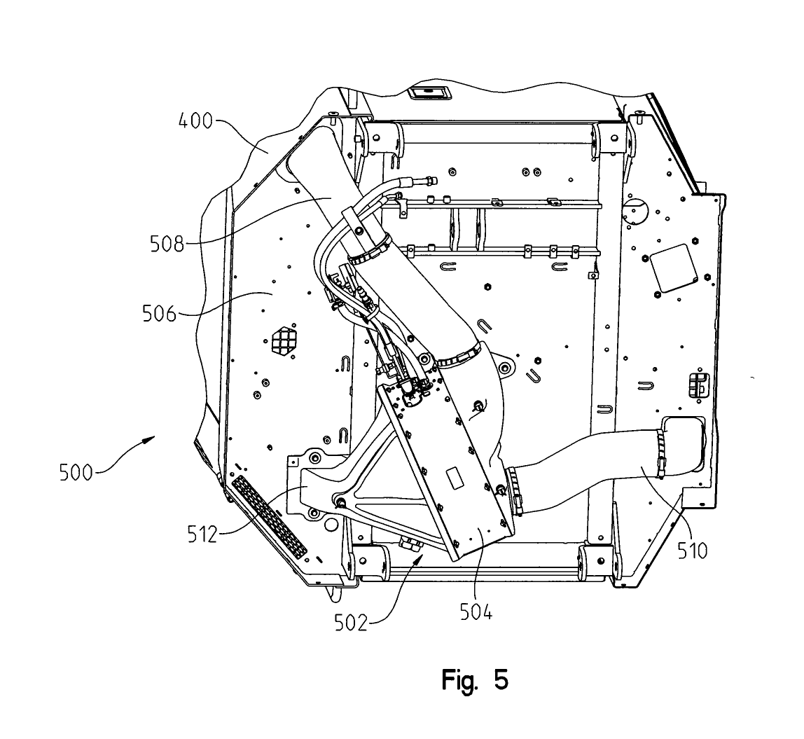

Referring to FIG. 5, a bottom portion 500 of the cab 400 is shown. The bottom portion 500 includes a bottom or floor panel 506 to which the seat 406 is mounted inside the cab 400 and to which the HVAC system 502 is coupled. As shown, the HVAC system 502 is disposed below the floor panel 506 of the cab 400. In particular, a space between the floor panel 506 of the cab 400 and chassis of the machine allows the HVAC system 502 to be disposed outside the cab 400. In this embodiment, the HVAC system 502 can be repackaged into a cassette-type module 504. In a skidder and feller buncher, for example, the cab 400 can be pivoted or tilted to access the transmission, fluid lines and hoses, and other components of the machine disposed beneath the cab 400. Therefore, to access the HVAC cassette module 504, the cab 400 can be pivoted from an upright position to a tilted position.

The HVAC system 502 can also include a first duct 508 and a second duct 510 that are coupled between the module 504 and floor panel 506 of the cab 400. In a skidder, for example, the first duct 508 can be coupled to the rear and the second duct 510 can be coupled to the front. In a feller buncher, however, the first duct 508 can be coupled to the front and the second duct 510 can be coupled to the rear. A third duct 512 is disposed between the floor panel 506 and the module 504. The third duct 512 can be coupled to the smaller portion 408 of the HVAC system 502 (e.g., blower and filters) as shown in FIG. 4. Air can be supplied to the third duct 512 and then transferred to the front and rear of the cab via the first duct 508 and second duct 510. With the HVAC system 502 disposed substantially outside of the cab 400, fluids and condensate remain outside the cab 400 as well. Moreover, by tilting the cab 400 to the tilted position, the module 504, ducts, hoses, etc. of the HVAC system can be easily serviced.

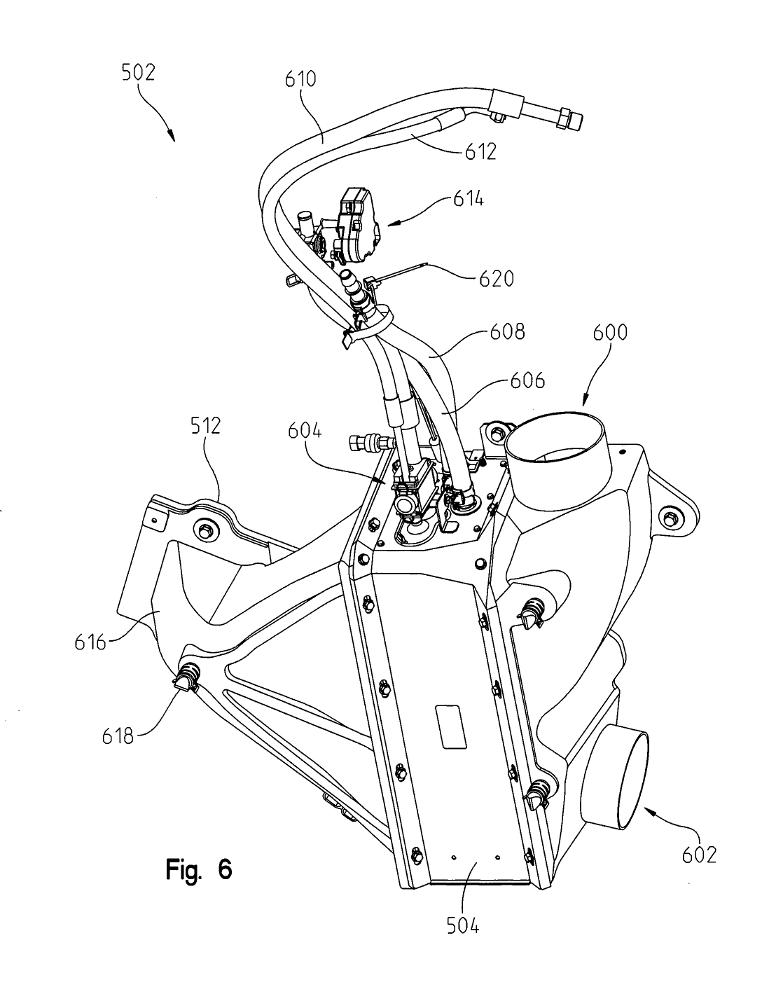

The HVAC system 502 is further shown in FIG. 6. The HVAC system 502 can include a first air outlet 600 and a second air outlet 602 to which the first duct 508 and second duct 510, respectively, are coupled. Thus, warm or cool air can be transferred to the interior 402 of the cab 400 via the air outlets 600, 602 of the HVAC system 502. The system 502 can also include a thermal expansion valve 604. The thermal expansion valve 604 can be part of the refrigerant system and is coupled to an evaporator core. The evaporator core (or assembly) is disposed as part of the module 504. During operation, the thermal expansion valve 604 can meter the flow of refrigerant to the evaporator core through different hoses or fluid lines.

The HVAC system 502 can also include a water valve 614 that is fluidly coupled to a first heater circuit supply line 606. The heater circuit (not shown) can also include a second line 608 that is configured as a return fluid line to the engine. The air conditioning portion of the HVAC system 502 can include a pair of hoses or fluid lines coupled to the HVAC module 504. A first line 610 can function as a suction hose and a second line 612 can function as a liquid or fluid line. In addition, the HVAC system 502 can include a freeze probe 620 for detecting temperatures at or below freezing in the evaporator core. The freeze probe 620 can be used to control the operation of the compressor (not shown).

Moreover, the HVAC system 502 can include a duct housing 616 coupled to the HVAC module 504. The duct housing can include the third duct 512 for coupling to the floor panel 506 of the cab 400. There can be one or more condensate drains 618 coupled to the HVAC system 502. Each condensate drain 618 can be used to release condensation from the HVAC system 502 in a safe and environmentally-friendly manner. Alternatively, the condensation drains 618 can be duck-billed shaped such that condensation from the evaporator, for example, leaks through an opening in the drain 618. In either aspect, the condensation is maintained outside the cab 400 unlike the conventional cab 200 of FIG. 2. Further, with the air conditioning lines 610, 612 and heater circuit lines 606, 608 disposed outside the cab 400, there is less risk of any fluid (e.g., refrigerant, coolant, etc.) leaking inside the cab 400. As already mentioned, there is increased space within the interior 402 of the cab 400 by removing the HVAC system from inside the cab and packaging it outside the cab 400.

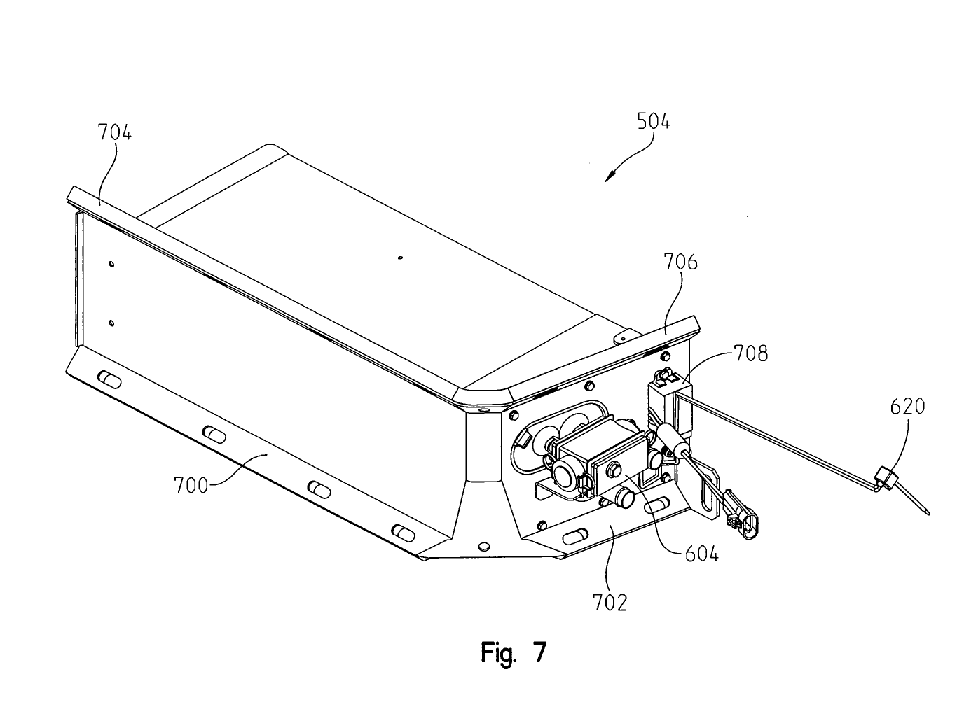

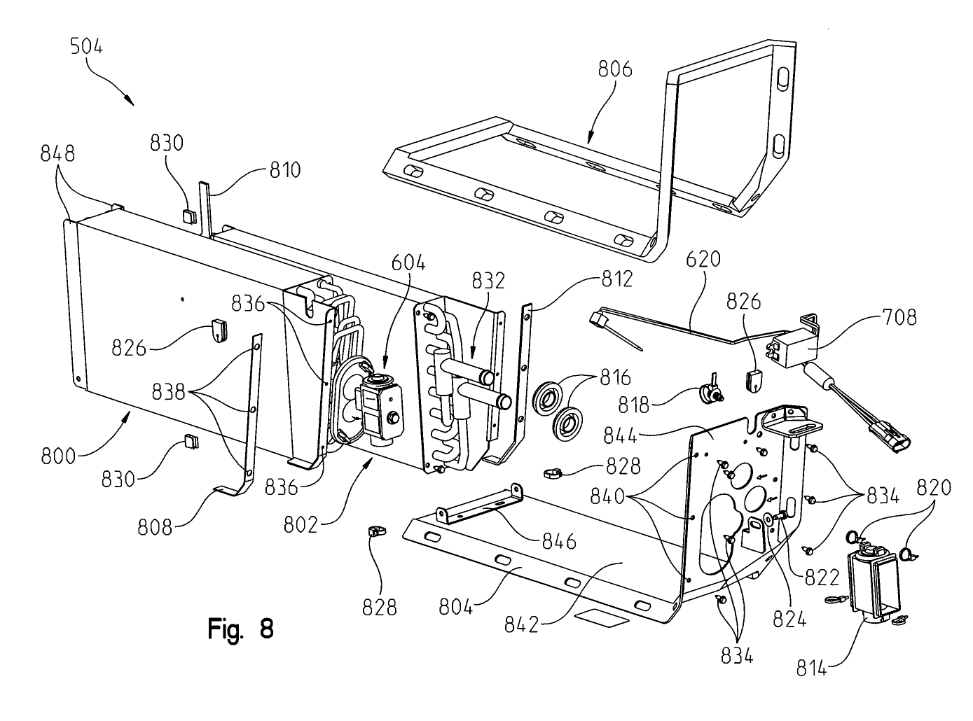

An additional advantage of the HVAC system of FIG. 4 is the serviceability and maintenance of the HVAC system 502. The majority of the HVAC system 502 can be packaged in the cassette-like module 504 of FIG. 5. The module 504 is further shown in FIGS. 7 and 8. In FIG. 7, the module 504 is shown having a first flange 700, a second flange 702, a third flange 704, and a fourth flange 706. Each flange can include a plurality of openings through which a fastener (not shown) can couple the first duct 508, second duct 510, and third duct 512 to the module 504. The module 504 can also include a thermostat switch 708 disposed approximately near the freeze probe 620. The thermostat switch 708 can regulate the condenser (not shown).

The packaged arrangement, or more specifically, the cassette-style HVAC module 504 can include a gasket foam (not shown) disposed around the exterior thereof The cassette module 504 can include one or more condensate drains (not shown) similar to the drains 618 of FIG. 6. In addition, the flanges (or brackets) allow the module 504 to be easily removed and replaced if necessary. In many instances, the cab 400 can be rotated and the module is easily accessible for maintenance. Moreover, the plurality of fasteners (e.g., bolts, screws, etc.) can be removed to either remove and replace the entire cassette module 504 or to service the interior of the module 504. Each module 504 can be simply removed and installed in a cassette-like manner, thereby making the HVAC system as a whole easier to service and maintain compared to conventional HVAC systems. In the case of where the entire module or sub-assembly needs to be replaced, the fluid lines and hoses can be easily disconnected therefrom. However, in many instances, the fluid lines and hoses can remain connected to the module during service.

Referring to FIG. 8, an exemplary embodiment of the internal components of the HVAC cassette module 504 is shown. The module 504 can include additional or fewer components of the HVAC system and FIG. 8 only represents a single embodiment of this disclosure. In this example, however, the module 504 can include an evaporator core or assembly 800 and a heater core or assembly 802. In the packaged arrangement of the module 504 in FIG. 8, the evaporator assembly 800 is disposed adjacent to or next to the heater assembly 802. Both the evaporator assembly 800 and heater assembly 802 can have substantially rectangular cross-sections, allowing each to be disposed next to one another and at least partially enclosed by an outer case (i.e., weldment or main case 804). The heater core or assembly 802 can include a heater circuit 832, as shown. The thermal expansion valve 604 is shown coupled to the evaporator core or assembly 800.

The evaporator core 800 and heater core 802 can be assembled or coupled to a weldment or main case 804. The main case 804 can include a first portion 842 and a second portion 844. The first portion 842 and second portion 844 can be disposed substantially perpendicular to one another. The first portion 842 can include a bracket 846 to which the evaporator core 800 and heater core 804 can be coupled thereto. For instance, the evaporator core 800 can include a pair of flanges 848 that extend from one end of the core 800 and at least one of the flanges 848 can have a defined opening through which a fastener (not shown) couples the core 800 to the bracket 846. The heater core 802 may also include a pair of flanges for coupling to the bracket 846.

The cassette module 504 can also include a series or plurality of gaskets or sealing members disposed between the different cores and main case. For instance, a cassette sealing gasket 806 includes portions that correspond with the different flanges of the cassette module 504. Moreover, a first gasket 808, a second gasket 810, and a third gasket 812 can provide support and seal the different interfaces between the evaporator core 800, heater core 802, and main case 804. The gaskets can reduce or prevent fluid leakage that may otherwise pose safety or environmental concerns.

The evaporator core 800 can include a plurality of defined openings 836 for coupled to the second portion 844 of the main case 804, which has its own set of defined openings 840. The first gasket 808 may also include a plurality of defined openings 838 for being disposed between the evaporator core 800 and main case 804. A plurality of fasteners 834 can be inserted through the plurality of openings defined in the first gasket 808 and evaporator core 800 for coupling the evaporator core 800 to the second portion 844. Similarly, the heater core 802 and second third gasket 812 can include a plurality of defined openings such that fasteners 834 can coupled the heater core 802 to the second portion 844.

The second portion 844 of the main case 804 can define a plurality of openings through which the fluid lines 610, 612 of the air conditioning unit or fluid lines 606, 608 of the heater circuit can pass through for coupling to either the evaporator core 800 or heater core 802. As also shown in FIG. 8, the cassette module 504 can include a boot 814 for being disposed over and protect the thermal expansion valve 604. Additional fasteners such as grommets 816 and 826, ties 818, 820, and 828, clips 830, screw 822 and washer 824 can be included in the packaging of the cassette module 504 for fastening or supporting each of the components to one another.

The cassette module 504 may include additional coverings, housings, gaskets, foam, and the like for supporting the hardware and components contained therein. Moreover, the cassette module 504 can be packaged in a different shape or the components can be packaged in various forms within the cassette module 504. Regardless of the design or packaging arrangement of the cassette module 504 within the HVAC system 502, the module 504 can be easily serviced or replaced. The module 504 can be structured as a “plug and play” module so that service time and machine down time are reduced compared to conventional HVAC systems.

While exemplary embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A cassette module for a HVAC system of a machine, comprising:
an outer case having a first side and a second side, the case including a first flange disposed at the first side and a second flange disposed at the second flange, where the first flange is adapted to couple to a first HVAC duct and the second flange is adapted to couple to a second HVAC duct;
an evaporator assembly including at least one flange for coupling to the outer case, the evaporator assembly being at least partially enclosed by the outer case; and
a heater assembly including at least one flange for coupling to the outer case, the heater assembly disposed adjacent to the evaporator assembly and being at least partially enclosed by the outer case.

2. The cassette module of claim 1, wherein the evaporator assembly and heater assembly are disposed adjacent to one another within the outer case.

3. The cassette module of claim 1, further comprising a thermal expansion valve for metering fluid flow to or from the evaporator assembly, the thermal expansion valve being coupled to the evaporator assembly.

4. The cassette module of claim 3, further comprising a boot member for substantially covering the thermal expansion valve.

5. The cassette module of claim 1, further comprising a water valve coupled to one of the outer case, the evaporator assembly, or the heater assembly.

6. The cassette module of claim 1, further comprising a first gasket and a second gasket, wherein:
the first gasket is disposed between the evaporator assembly and the outer case; and
the second gasket is disposed between the heater assembly and the outer case.

7. The cassette module of claim 1, further comprising a freeze probe adapted to detect a temperature in the evaporator assembly, the freeze probe being coupled to the outer case or evaporator assembly.

8. The cassette module of claim 1, further comprising a bracket coupled between the outer case, evaporator assembly, and heater assembly.

9. The cassette module of claim 1, further comprising a first plurality of fluid lines and a second plurality of fluid lines, the first plurality of fluid lines coupled to the evaporator assembly and the second plurality of fluid lines coupled to the heater assembly;
wherein, the outer case includes defined openings through which the first plurality of fluid lines and second plurality of fluid lines protrude.

10. A machine having at least one traction device, comprising:
a frame adapted to be supported by the at least one traction device;
a cab pivotably coupled to the frame, where the cab includes a floor panel;
a HVAC system having a first portion and a second portion, the first portion being at least partially disposed in the cab and the second portion being coupled to the floor panel substantially underneath the cab;
wherein, the second portion includes a HVAC cassette module accessible from outside the cab.

11. The machine of claim 10, wherein the HVAC cassette module comprises:
an outer case being removably coupled to the second portion of the HVAC system;
an evaporator assembly coupled to and being at least partially enclosed by the outer case; and
a heater assembly coupled to and being at least partially enclosed by the outer case.

12. The machine of claim 10, wherein the first portion comprises a blower motor and a filter, the blower motor and filter being accessible from inside the cab.

13. The cassette module of claim 11, wherein the evaporator assembly and heater assembly are disposed adjacent to one another within the outer case.

14. The cassette module of claim 11, further comprising a thermal expansion valve for metering fluid flow to or from the evaporator assembly, the thermal expansion valve being coupled to the evaporator assembly.

15. The cassette module of claim 11, further comprising a water valve coupled to the second portion of the HVAC system or the cassette module.

16. The cassette module of claim 11, further comprising a freeze probe adapted to detect a temperature in the evaporator assembly, the freeze probe being coupled to the outer case or evaporator assembly.

17. The cassette module of claim 11, further comprising a bracket coupled between the outer case, evaporator assembly, and heater assembly.

18. The cassette module of claim 11, further comprising a first plurality of fluid lines and a second plurality of fluid lines, the first plurality of fluid lines coupled to the evaporator assembly and the second plurality of fluid lines coupled to the heater assembly;
wherein, the outer case includes defined openings through which the first plurality of fluid lines and second plurality of fluid lines protrude.

19. The machine of claim 10, further comprising:
a first duct disposed underneath the cab, the first duct coupled between the first portion and the HVAC cassette module; and
a second duct disposed underneath cab, the second duct coupled to the HVAC cassette module and having a first duct path and a second duct path.

20. The machine of claim 13, further comprising at least one condensate drain coupled to the second portion of the HVAC system and disposed underneath the cab.
